(19) United States
(12) Patent Application Publication
(10) Pub. No.: US 2004/0019501 A1
(43) Pub. Date: Jan. 29, 2004

(54) Patient scheduling, tracking and status system

(76) Inventors: Scott B. White, Colorado Springs, CO (US); Paul M. Sherwood, Colorado Springs, CO (US); John L. Sherman, Colorado Springs, CO (US); Tanweer Khan, Colorado Springs, CO (US); Richard A. Van Eaton JR., Colorado Springs, CO (US)

Correspondence Address: HOLME ROBERTS & OWEN, L.L.P., SUITE 1300, 90 SOUTH CASCADE AVENUE, COLORADO SPRINGS, CO, 80903, US

(21) Appl. No.: 10/206,799

(22) Filed: Jul. 27, 2002

(51) Int. Cl. G06F 17/60

(52) U.S. Cl. 705/2

(57) ABSTRACT

The present invention includes a computer-assisted system for scheduling, tracking and providing the status of patient cases undergoing a medical testing process. The system includes a scheduling application program, a patient tracking application, and a patient status grid. The patient tracking application provides patient queues for each selected step in the testing process, which enable staff members carrying out the testing process to prioritize patient cases and organize completion of multiple steps in the testing process as to each patient case.

The inventors, under Rule 37 CFR 1.27, for this non-provisional application is a small entity.

### BACKGROUND

1. Field of the Invention

The field of the system is medical practice management and, in particular, systems configured to manage a diagnostic imaging medical practice.

2. State of the Related Art

In a climate of increasing operating costs and mounting efforts by insurance companies to curtail payments for medical services, there is considerable pressure to improve productivity and efficiency and thereby increase revenues of medical practices.

In the medical practice area of medical testing and, in particular, diagnostic imaging, payments are ordinarily made as a flat fee per test completed. An imaging facility's profitability is in part a function of volume of tests performed.

Diagnostic imaging usually is carried out in a clinic environment where the staff performs specific functions on a repetitive basis to cause the testing process to be routine, efficient and reliable. One function is reception, which involves scheduling and intake on arrival, and data gathering. Medical testing is usually performed by a paraprofessional such as an x-ray technician, medical technologist, or the like. After the image is taken, analysis is typically effected by a medical doctor who has specialized in some way so that he/she can read and in turn analyze the films and prepare reports based upon the films, such as a radiologist. The reports are typically given to the referring physician. In some clinics, the radiologist's report is dictated and a transcriptionist types the report, which is then reviewed for accuracy by the radiologist before delivery to the referring physician.

Many diagnostic imaging clinics carry out more than one type of exam, such as MRI (magnetic resonance imaging), CT (computed tomography) scans, and the x-ray exams. Such clinics can be expected to have several technologists and radiologists all conducting exams and reading films at any point in time. Organizing the flow of patients and test results through such clinics is presently understood to be largely a manual process that can lead to delays, unused appointments, unused equipment and idle staff. Reduction in the time taken to complete any step in the testing process can greatly enhance the volume of tests completed over a given time period and therefore also increase efficiency. Further, an efficient clinic may receive more referrals from referring physicians.

Various computer-aided scheduling systems have been developed, which facilitate matching of patients to available appointment times. Examples include Cummings, U.S. Pat. No. 6,345,260 B1 and Detjen, U.S. Pat. No. 5,970,466. These systems are believed to have little effect on the flow of patients through the testing or medical care process that follows scheduling. Various authorities describe computer-supported medical care schedules, but these are believed to provide a plan for treatment for individual patients, and not work flow management tools for medical staff dealing with large volumes of patients flowing through multi-step processes within the same time period. Examples include Kameda, U.S. Pat. Nos. 5,913,197, 5,923,018, 6,321,203B1, and EP 1 081 626 A2 17/08/2000. Other systems provide computer support for automatically obtaining and sending exam information from one or more imaging devices, see Pomeroy, EP 1 160 716 A2, but these systems are not believed to address patient flows through the imaging site and work flows across the radiologist's desk or screen. Other systems address overall medical facility management, see Crane, U.S. Pat. No. 5,748,907, and are not believed to focus on patient case workload management.

### SUMMARY

A computer system for managing medical testing of a plurality of patient cases, each patient case involving a single patient who is to undergo at least one medical test having multiple steps. The multiple steps include data collection and data evaluation. In a preferred embodiment, the computer system includes a computer network. The computer network has a server means, a cable means, and a plurality of work stations. The server means includes a processor means and a memory means interconnected to said processor. The processor is configured to process data reflective of a plurality of patient cases in accordance with a program. In one embodiment, the program includes a scheduling means, and a patient tracking means. In a preferred embodiment, the program includes a scheduling means, a patient tracking means, and a patient status grid means. In an alternate embodiment, the program includes only a patient tracking means, and in a further embodiment, the program includes only a patient status grid means. In yet another embodiment, the program only includes a scheduling means.

The scheduling means is a means for scheduling each of a plurality of patients for an appointment to undergo at least one medical test having multiple steps. The multiple steps include data collection and evaluation. The patient tracking means includes a queue definition means for establishing patient queues, each of the patient queues including a group of patient cases, and each queue having data reflective of the patient cases within the queue and of the status of at least one of the multiple steps involved in the medical test. The patient tracking means also includes a patient queue priority means for placing each patient case in at least one patient queue in accordance with a preselected plan or program to complete the multiple steps of the medical test. In a preferred embodiment, involving radiological testing, the queue definition means establishes a reception queue, a technologist queue, and a radiologist queue. Another embodiment includes these three queues, and also a transcriptionist queue and a delivery queue. The patient status grid means includes time analysis means for recording, for each patient case of a selected group of patient cases, the time of completion of each of the multiple steps in the medical test applicable to the patient case, and of comparing the recorded time of completion to a preselected time of completion for each step. The patient status grid means presents a display arrangement, providing data reflective of the patient cases included in the patient status grid.

The memory means of the present system is configured for receiving, storing and supplying data reflective of the plurality of patient cases. The cable means is connected to the server means and the plurality of work stations, for the purpose of sending and receiving information reflective of the plurality of patient cases. Each of the plurality of work stations includes an input means to receive data reflective of the status of a patient case from a user, and an output means to display for observation by a user data relating to a patient case, and to a plurality of patient cases, including a patient queue, and a patient status grid.

### BRIEF DESCRIPTION OF THE DRAWINGS

FIG. 1 is a diagram depicting the network structure of an embodiment of the present system.

FIG. 2 is a flow diagram of an embodiment of the scheduler application of an embodiment of the system.

FIG. 2A is a diagram depicting an embodiment of a patient scheduler window.

FIG. 3 is a flow diagram of an embodiment of the receptionist queue of the patient tracker application of the system.

FIG. 3A is a diagram depicting an embodiment of a receptionist queue window.

FIG. 4 is a flow diagram of an embodiment of the technologist queue of the patient tracker application of the system.

FIG. 4A is a diagram depicting an embodiment of a technologist queue window.

FIG. 5 is a flow diagram of an embodiment of the radiologist queue of the patient tracker application of the system.

FIG. 5A is a diagram depicting an embodiment of a radiologist queue window.

FIG. 6 is a flow diagram of an alternative embodiment of the radiologist queue of the patient tracker application of the system.

FIG. 7 is a flow diagram of an embodiment of the transcriptionist queue of the patient tracker application of the system.

FIG. 7A is a diagram of an embodiment of a transcriptionist queue window.

FIG. 8 is a flow diagram of an embodiment of the delivery queue of the patient tracker application of the system.

FIG. 8A is a diagram of an embodiment of a delivery queue window.

FIG. 9 is a diagram of an embodiment of the patient status grid application of the system.

FIG. 9A is a diagram of another embodiment of the patient status grid application of the system.

### DETAILED DESCRIPTION

A computer-based system for managing medical testing of patients, the present embodiment of the system being specifically adapted to diagnostic testing. The system is most advantageously applied in the context of a medical testing process that involves a series of steps. The system provides special benefits in a clinical context where the clinic is charged with performing diagnostic testing of a large volume of patients, and the steps in the testing process are performed by multiple staff members. The system permits the staff members to define the steps in the medical testing process, to track the flow of patients from step to step in the medical testing process, to record the completion of steps as to individual patients, and to organize priorities for staff members carrying out each step.

The embodiment described herein involves radiological testing and in particular diagnostic imaging, such as MRI, CT and x-ray testing. The present embodiment includes software application programs carried out in a computer network system. The application programs may be presented as a Microsoft Windows™ solution, although other software systems may be utilized, such as a UNIX-based system. As will be understood by those familiar with the art, adjustments may have to be made to adapt the present system to another software system, but the same advantages and effects can be achieved. The network arrangement of the present embodiment includes at least one server, containing a memory or data storage facility, and a processor. The server is configured to implement the application programs. The network includes multiple work stations, each work station including an input means, such as a keyboard and/or mouse, and an output means, such as a CRT, for reviewing stored information or results of processor operations. The network is interconnected by cables or may be a wireless or cableless equivalent.

In a preferred embodiment, the system is a networked system in which a server means includes several server modules, including a database server and file server, containing the memory means, an application server, which functions to process application programs of the system, and a data transfer server for communicating with system users and other persons outside the networked system, who may perform steps in the testing process (such as outsourced radiologists reading films and preparing reports, or transcriptionists), or referring physicians and insurance companies to whom reports are sent. The server means is then connected to a plurality of work stations, each having a means for inputting (receiving from users) information and a means for reviewing output information. Additionally, in one arrangement of this preferred embodiment, the system also includes exam (or test) administration equipment linked to the network, as well as one or more viewers, by which personnel can view images produced by the exam administration equipment. In the present embodiment, the input means is a keyboard and mouse arrangement although other input systems can be substituted including interactive screen arrangements and voice-activated systems. The output means is a monitor having a cathode ray tube screen system, although other output or display systems can be substituted. The output means displays patient and medical testing information inputted by the user, retrieved from the system's database server or file servers, and produced by the system's application server.

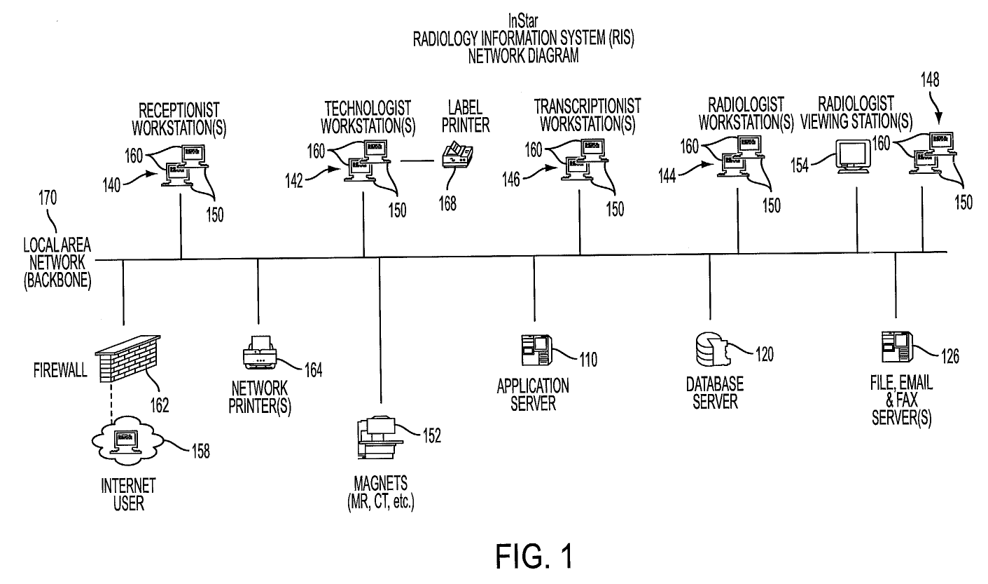

As depicted in FIG. 1, the network 100 of the present embodiment is structured with a server means that includes an application server 110, a database server 120, and a combined file server and data transfer server 126, which are each connected to work stations 140, 142, 144, 146, 148, each workstation having keyboards 150 and monitors 160. There may be one or more work stations in each area, and a smaller or larger number of work stations can be substituted, depending on the number of users desired and functions to be serviced. FIG. 1 depicts two work stations for each user area.

In a simplified but preferred embodiment, work station 140 is used by a receptionist, who also functions as a scheduler; work station 142 is used by a medical technologist, who performs exam administration; work station 144 is used by a radiologist, who reviews exam films and images and prepares reports by dictation, work station 146 is used by a transcriptionist; who transcribes reports dictated by the radiologist, and work station 148 is used by a staff person responsible for delivery of completed reports. FIG. 1 depicts radiological exam equipment 152, operated by the medical technologist, including imaging equipment such as MRI and CT equipment, and a work station viewer and software for viewing, processing and forwarding images. FIG. 1 also depicts a radiological viewing station 154, which also includes a work station viewer, with imaging software, used by the radiologist to view and process images produced by the radiological exam equipment 152. In the present embodiment, the radiological exam equipment 152 and radiological viewing station 154 are linked to the computer network, although in other embodiments of the present system, such equipment can be independent of the network 100.

In further embodiments of the system, other kinds of diagnostic imaging equipment, testing equipment, or testing procedures may be used, or substituted, for the radiological exam equipment 152, such as testing facilities for mammography, fluoroscopy, and alcohol or drug content in blood, breath, or urine. Additionally, in an alternate embodiment, the system includes video-imaging equipment, in which medical personnel examine internal body systems using mini-cameras that provide images to a display that can be reviewed on a real-time basis.

Users of the network of the present embodiment have access to the Internet and to Internet users 158, albeit through a firewall 162 for protection of the system from unauthorized users and intrusions. In the present embodiment, other items of hardware are linked to the system, such as network printers 164 and label printers 168 as depicted in FIG. 1. In alternate embodiments, such equipment may be omitted from the system, or alternate items of equipment may be used. In the present system, the work stations, servers, exam equipment, viewers, and other features of the system described above are linked together through a cable means, a cable framework including a local area network backbone 170. It should be noted that various other communications links, including other cable systems and wireless links, may be substituted. Further, although not depicted in FIG. 1, the system also includes a power supply, that furnishes power to the network.

Other embodiments of the networked system described herein can include use of multiple receptionists, each with a separate work station, and where the scheduling and reception functions are divided, each with separate work stations. Similarly, further embodiments have multiple radiologists and multiple technologists, each with separate work stations. In other embodiments, there are fewer functional areas (for example, a system where there is no transcriptionist work station, and no delivery work station) or additional functional areas and work stations (such as a billing administrator work station). The present description is not intended to limit the invention to the structure, and number or type of work stations, depicted in FIG. 1. Further, the present description is also not intended to limit the structure to a networked arrangement employing linked servers and workstations. Other structures for providing memory and processor facilities, and user interfaces linked to the memory and processor facilities, can be substituted with the same effect and advantages.

The preferred embodiment further includes application programs configured on the server means to provide scheduling and patient tracking functions. In the present embodiment, these application programs are integrated in various ways; for example, all or a portion of the information inputted in the scheduling function is utilized by the patient tracking function. In a highly preferred embodiment described below, the system also has a patient status grid function, embodied in an application program, which is integrated with the scheduling and patient tracking function. Each application program, including the patient tracking system, patient status grid and scheduling system, can operate independently on the computer network of the present embodiment, or on another alternative computer system that provides the basic functions of a processor, memory, input means and output means. While a preferred embodiment involves configuring the computer system and application programs so that they operate together, in an integrated fashion, another embodiment involves a system where each application program, that of the scheduling application, the patient status program, and the patient status grid, can be operated independently of the others.

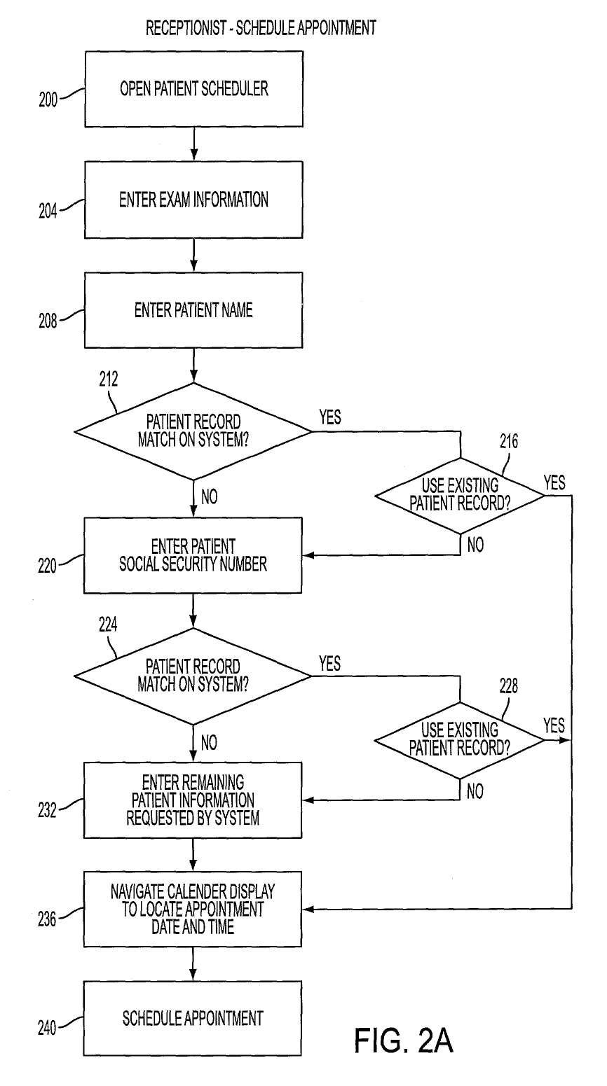

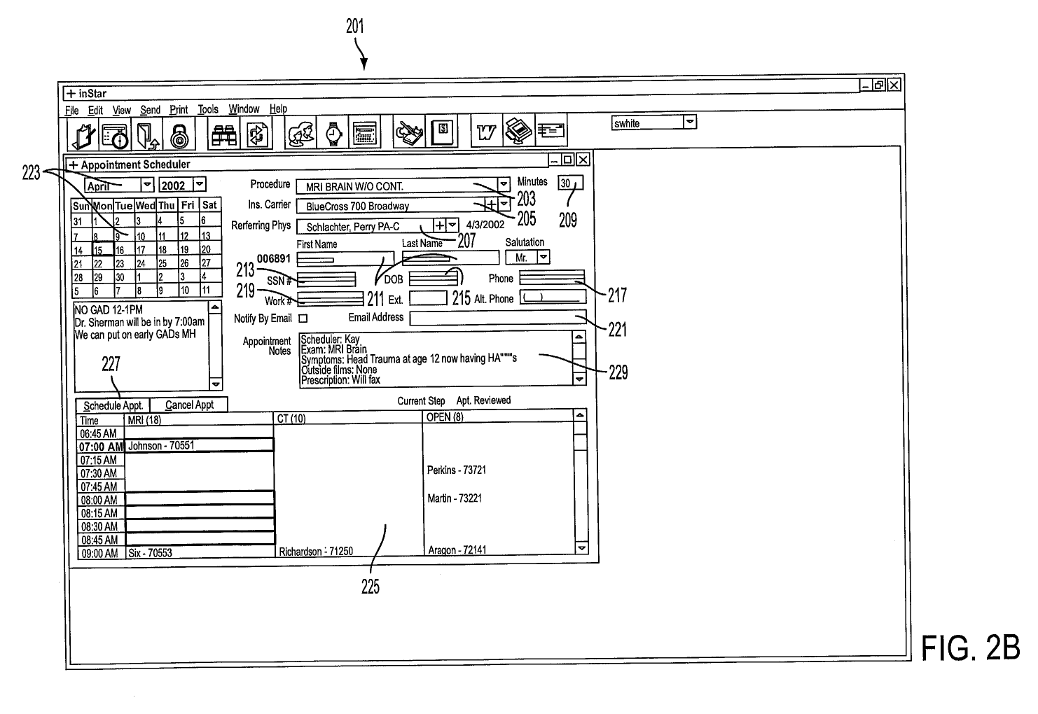

The present embodiment includes a patient scheduler software program that permits the scheduling of patient appointments and also the development of online and hardcopy patient records for use in exam administration and report preparation and review. As depicted in the flow diagram of FIG. 2, a user (a receptionist, staff scheduler, or other staff member responsible for scheduling) first enters an input to open the patient scheduler 200, which opens a scheduler window displaying various fields to be completed by the user. These fields can be completed by moving a cursor to the field and then entering information in the field. The first fields include test procedure to be performed, insurance carrier, and referring physician, which together can be referred to as exam information. Once the user enters the exam information 204, the user then completes the patient name field 208. The system then queries whether the patient has an existing patient record match on the system 212 and searches for an existing patient record matching the patient's name. If a record is found, the system displays a dialog box providing a link to any patient record that matches the patient's name, allowing the user to review the patient record in detail, and asks whether the user wishes to accept this record 216. If no record is found, the next step is for the user to enter the patient's Social Security number 220. The system then again searches for a possible match with an existing patient record having the same Social Security number as has been entered, and queries again whether there is an existing patient record match 224. If a patient record is found, the system displays to the user a dialog box providing a link permitting the user to review this information and asks whether the user wishes to accept the existing patient record match displayed 228. If no patient record is found or the existing record match is not accepted, the user may then proceed to enter the additional patient information requested by the system 232. If the patient record is found and accepted after the step of entering the Social Security number, the system uses this information to complete the remaining patient information fields, and the user can then move on to navigate the calendar display of the window to locate an appointment date and time acceptable to the patient 236, and then proceed to schedule an appointment 240.

The scheduler application then enters the patient appointment in the patient tracking system, on the scheduled date and time, and the patient appointment accordingly is included in a receptionist queue (and other selected queues, and the patient status grid, as desired) for the date on which the appointment has been scheduled. Further, the patient record (all or a portion of the information submitted by the scheduler, or the existing patient record, if accepted) becomes the online patient record for the appointment, which may be accessed by users of the patient tracking system.

FIG. 2A provides further illustration of the scheduling application of the system. FIG. 2A depicts a window of the present embodiment displaying the appointment scheduler. It should be noted that the software of the present system includes at least one preliminary parent window that is first opened, with a toolbar that enables the user to select and open the appointment scheduler option. Other choices include the patient tracking application, patient status grid, and report building application (in this embodiment, a Microsoft Word application).

Once the patient scheduler application is opened, the scheduling window 201 depicted in FIG. 2A is displayed to the user on the user's work station monitor. The window 201 includes a number of fields to be completed by the user, be entering information in each of the fields. The first three fields to be completed are the exam information, including the test procedure 203, the insurance carrier 205 and referring physical 207. Additionally, the user completes the duration of appointment, which is referred to on the window 201 as “minutes” 209. The user then enters patient name (first name, last name) 211. At this point, the system of the present embodiment searches for a matching patient record with the same name, and provides a dialog box that enables the user to review any record found. If a record is found and accepted by the user, the system uses that record to complete the rest of the patient information fields. If not, the user then completes the patient Social Security number field 213. Once again, the system queries whether there is a matching patient record. If so, and if the record is accepted, the system uses this information to complete the remaining patient information fields. If not, the user completes these fields, which include data of birth 215, phone number 217, work number 219, and email address 221. The user then proceeds to navigate the calendar display 223 to check appointment times by month, year, and date. The user then enters the patient name in an available time slot in the schedule for the date selected 225, and activates the schedule button 227 to enter the appointment on the system. A further feature of the scheduling window is the option of entering appointment notes 229, including special notices or alerts to those staff completing the exam. It should be noted that other information fields may be used for the scheduler application, and that the window may be formatted differently, and the present description is not intended to limit the system to the embodiment depicted.

The present embodiment permits all users of the patient tracking system to access the patient information submitted via the scheduling application and other application programs, although in other embodiments, only certain personnel of a medical facility, and accordingly, only certain users of the patient tracking system have access to the entire patient record, including patient medical information. Under privacy rules recently promulgated under federal law and expected to become effective in the near future, only certain personnel may have access to patient medical information, and the patient may have to provide appropriate consents to authorize certain personnel to have access to patient information. Alternative embodiments of the present invention involve limitations on user access to the system and to certain patient information on the system, as well as security programs, including fields for confirming that appropriate patient consents have been given. These may be included in the parent window or scheduling window, or in other input windows of the system.

The present embodiment includes a patient tracking system which is installed on the server means. The patient tracking system interfaces with the patient scheduler, and information flowing from the patient scheduler is utilized by the patient tracking system and its users. The patient scheduler functions to enter a plurality of patients on various appointment days, in time slots of varying duration on those appointment days. Each time the patient scheduler is used to schedule a patient appointment, a patient case is initiated. Each patient case involves a single patient undergoing an exam procedure, also called a medical testing process, the medical testing process involving a plurality of steps. Each patient case is ordinarily associated with a patient record, which includes the information inputted by the user of the patient scheduler and information inputted by users of the patient tracking means, including appointment notes, and a report generated by the radiologist who reviews the film or image produced by the exam equipment. While the patient may only be in the clinic for a short period of time, such as during reception and exam administration, the patient case associated with that patient continues thereafter to move through the patient tracking system, as the patient's exam results are processed, reviewed by the radiologist, and used to generate a report which is sent to the patient and/or his referring physician.

The patient tracker of the present embodiment permits its users to monitor patient cases as they move through selected steps of a medical testing process. Additionally, the patient tracker permits users, who are carrying out selected steps of the medical testing process, as well as other authorized users, to organize and prioritize patient cases that are awaiting completion of specific steps in the medical testing process. In the present embodiment, the patient tracker includes a time analysis function, which enables a user to determine when specific steps in the medical testing process have been completed as to individual patient cases. The time analysis function provides a “time stamp” for each notation inputted by a user confirming that a step in the medical testing process has been completed. The time stamp is displayed alongside the last completed step in a patient case displayed in one or more patient queues. The time stamp for the last completed step of patient cases can be used, as discussed more fully below, to prioritize the patient cases in a specific patient queue.

The patient tracker involves a means for defining and the establishment of patient queues, each of which corresponds to one or more selected steps in the medical testing process. Each patient queue also corresponds to an area, department, or individual staff member in the organization responsible for carrying out a part of the medical testing process. The present embodiment involves means for organizing the selected steps of a medical testing process sequentially according to clinical order of performance in the testing process, grouping the steps by department, and assigning the steps to patient queues associated with each department queue. These selected steps include data collection and data evaluation functions. In alternate embodiments, other protocols and rationales for organizing the steps, including business considerations, determine the selection and sequencing of steps, and accordingly the establishment of patient queues. It should be noted that the user defines what steps in the medical testing process are important to track by the system, and the user might decide that certain steps will not be tracked. In the present embodiment, the patient tracker includes at least five patient queues, a receptionist queue, a technologist queue, a radiologist queue, a transcriptionist queue, and a delivery queue. Each queue represents a set of patient cases awaiting completion of specific steps in the medical testing process associated with the queue. The patient tracker includes a means for assigning patient cases to selected queues. In an alternate embodiment, at least a portion of those patient cases may also be awaiting completion of previous steps in the sequence, associated with another queue. These patient cases are associated with the following queue for information purposes, to inform those staff members responsible for the queue that a group of patient cases is “in the pipeline” of the previous queue, although not immediately ready for performance of steps associated with the queue.

In the present embodiment, the receptionist queue includes patient cases where the patient has been scheduled but has not arrived, patient cases where the patient has arrived, and patient cases where the patient is confirmed as ready for exam. The patient tracker includes a patient queue display means that is configured to display a representation of each patient queue, either individually, or associated with other patient queues. Each representation includes a list of patient names associated with each patient queue, and a notation for each patient case, indicating the last step in the medical testing process completed as to the patient case. Each notation is inputted to the patient tracker by a user via a patient status input means linked to one of the work stations of the system.

The patient tracker also includes a means for prioritizing patient cases within each patient queue, and as between queues. This prioritizing means is user defined, and the patient can establish rules for sorting and ordering patient cases in the queues. For example, the user might establish a rule that sorts cases according to specific steps completed. All patient cases for the time period selected (for example, the day's workload) awaiting completion of a specific step will be displayed together, and patient cases awaiting completion of another step will be grouped together. In an alternate embodiment, the user may groups patient cases according to a first in, first out rule, and cases will be sorted in order according to when they first became available for action by the area represented by the queue. In this embodiment, the time stamp function described above is important to establish a basis for the ordering process. In another embodiment, the user may sort patient cases according to referring physician. For example, if one referring physician is a surgeon, who requires expedited turnaround for purposes of surgery, the user can establish a group of patient cases referred by this physician, so that these cases can be given priority. The present description is not intended to limit the rules that can be established to sort or order patient cases within patient queues, or as between patient queues.

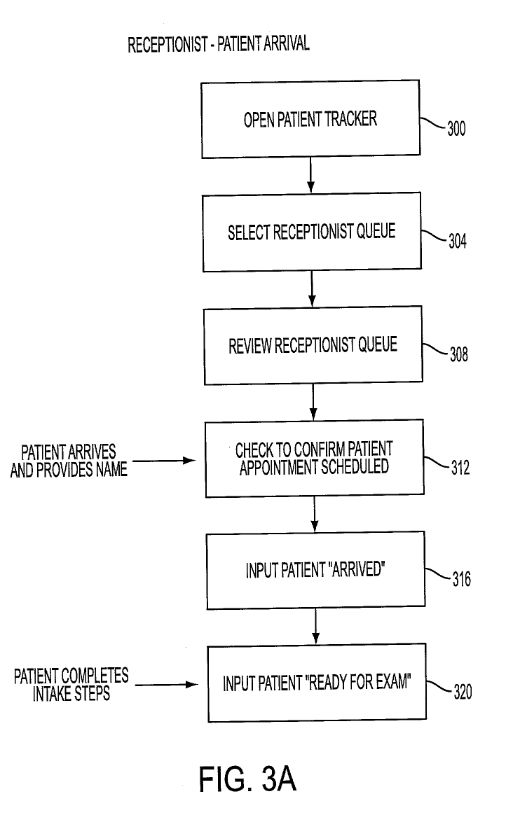

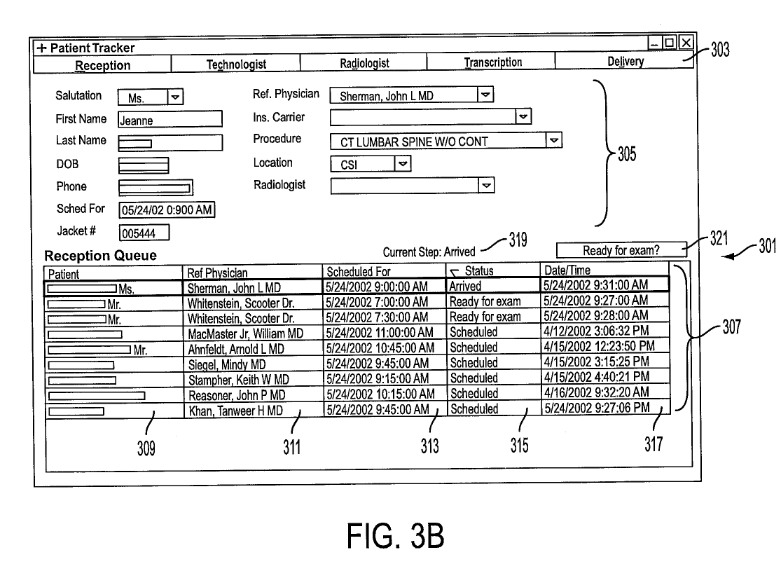

In the case of the receptionist queue, and referring to FIG. 3, the user first opens the patient tracker 300, selects the receptionist queue 304, and reviews the receptionist queue 308. When a patient arrives and identifies herself, the user checks to confirm the patient is listed on the patient queue as “scheduled” 312. On confirming the patient is scheduled 312, the user completes the procedure of inputting that the patient has “arrived” 316. Once an intake process is completed, the user inputs “ready for exam” 320 utilizing the patient status input means.

FIG. 3A provides further illustration of the reception queue of the patient tracker. FIG. 3A depicts a reception window 301 of the present embodiment displaying the reception queue. The top of the window includes a tool bar 303, which enables the user to open windows that display the other patient queues of the patient tracker, the technologist, radiologist, transcription, and delivery queues. Beneath the tool bar 303, is a patient record section 305, which displays individual patient information entered via the patient scheduler application. The lower portion of the window is the reception queue 307. This is arranged in a chart format, although other methods of displaying the information can be envisioned. The far left column is a patient name column 309. To the right of the patient name column 309, is a referring physician column 311, providing the name of the patient's referring physician, an appointment time column 313 depicting the date and time of the patient's appointment scheduled via the scheduler application, the patient status column 315, which provides a notation entered by the user as to the last step completed in the medical testing process, and a time stamp column 317, which indicates the date and time the last step completed notation was inputted in the patient tracker. As the user reads horizontally across from each patient name, the user is able to view the relevant information for that patient. When the user clicks on a patient name, the entire line of information relevant to that patient, and the current patient case, is highlighted, and the patient record information for that patient is displayed in the patient record section 305.

The reception queue window 301 includes click-on input buttons by which the user can note a change in the step completed for the patient, on “arrived” 319 and “ready for exam” 321 buttons. When the patient name of a patient case is highlighted, the user can click on the “arrived” button or “ready for exam” 321 buttons to change the entry in the patient status column 315. In this embodiment of the reception queue, there are two status steps that can be entered (arrived and ready for exam) although other steps could be utilized in other embodiments. When a status button is activated, the system automatically time stamps the step completed, and displays the date and time in the column alongside the new status entry display in the patient status column 315. It should be noted that the system includes a prioritization function that enables the user to prioritize patient cases in the patient queues, including the reception queue. For example, in status column, the user can click on an error button that enables the user to toggle between sorting the cases in descending or ascending order, according to the step completed. In other embodiments, other prioritization schemes are used, for example a scheme that orders the patient cases according to appointment time, and the present description is not intended to limit the prioritization rules that can be utilized.

It should be noted that the present embodiment generates a “jacket number” for each patient in the system. This is ordinarily generated when the patient “arrives” for his first appointment, and is retained for use with the patient record and all future appointments. Referring again to FIG. 2A, the jacket number 229 is located next to the patient's first name. The jacket number may be used in hard copies of records generated for the patient, including a hard copy patient file. The generation and use of a jacket number or other patient number is an optional feature of the system, and other embodiments of the system omit such a number generation feature, or involve other approaches, such as use of the patient's Social Security number as a file or jack number for patient records.

In the present embodiment, the exam administration area operates according to another queue in the patient tracker, the technologist queue. In the radiology field, diagnostic imaging equipment is ordinarily operated by a trained medical technologist, although persons with other occupational training or backgrounds may carry out this function. Once the patient is “ready for exam” the patient is directed to the exam administration area, where the technologist completes the exam.

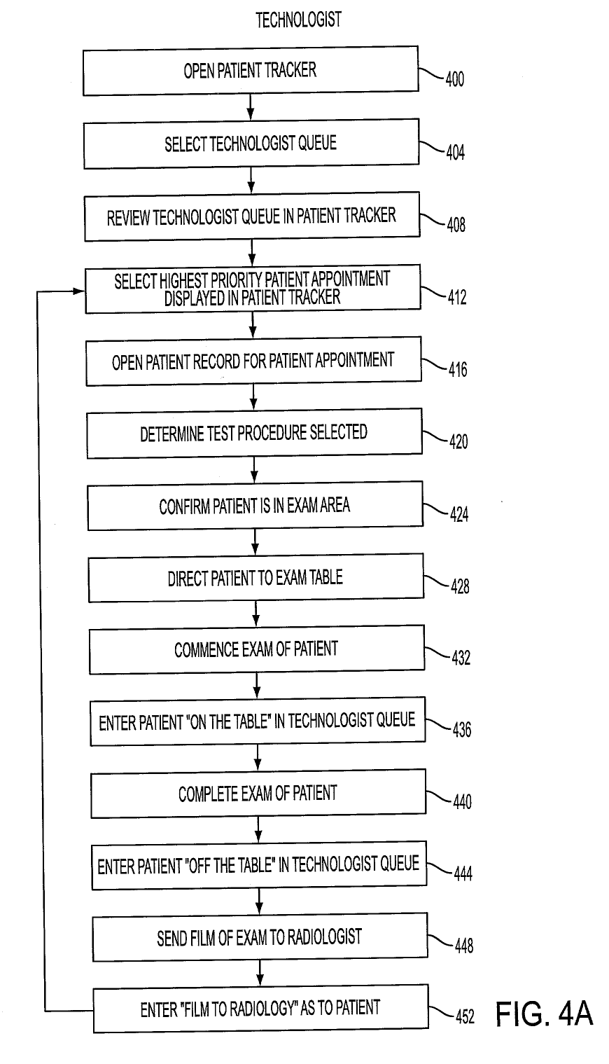

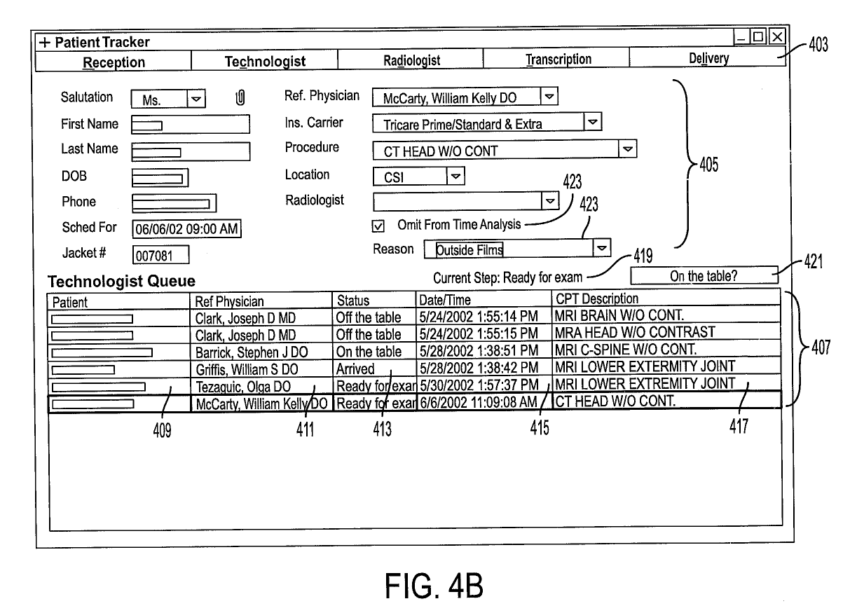

Referring to FIG. 4, the technologist first completes the steps of opening the patient tracker 400, selecting the technologist queue 404 and reviewing the technologist queue 408. The technologist then selects the highest priority patient case displayed in the patient tracker 412.

Once a patient case is selected 412, the technologist completes the steps of opening the patient record associated with the patient case 416, determining the exam procedure to be performed 420, confirming the patient is in the exam area 424, directing the patient to the exam table 428, commencing the exam 432, and inputting a notation in the patient tracker that patient is “on the table” 436, signifying commencement of the exam. When the technologist completes the exam 440, the technologist enters the notation that patient is “off the table” 444, and sends the exam results to the radiologist 448. In the present embodiment, this is accomplished by entering the results on the network, and sending the results via the network as an electronic image. Once the technologist sends the results (film or an image) to the radiologist, the technologist inputs “films to radiology” 452 in the patient tracker, and this notation then appears in the technologist's queue and the radiologist's queue signifying that the film or image associated with this patient case is ready for review by the radiologist.

FIG. 4A further illustrates the technologist queue of the present embodiment, by depicting the technologist queue window 401 displayed to the user by the patient tracker application. Referring to FIG. 4A, the technologist queue window 401, which is opened via a button on the tool bar of a parent window, includes a tool bar 403 that includes buttons that open the various patient queue windows of the patient tracker application. The technologist queue window 401 functions interactively in a manner similar to the reception queue window discussed above (see FIG. 3A). The technologist queue window 401 includes a patient information area 405, where patient record information inputted by the scheduler application is displayed. The window 401 also includes a representation of the technologist queue 407 formatted in a chart arrangement, and including a patient name column 409, a referring physician column 411, a patient status column 413, which displays the last step in the medical testing process completed as to the patient, a time stamp column 415, which displays the date and time the notation as to the last step completed was inputted by the user, and a CPT (Common Procedural Terminology) Description column 417, which describes the test procedure of the patient case and ordinarily also includes the region of the patient's body examined or to be examined . As with the reception queue, the user can select a patient name in the patient name column 409 and read across the columns to the left, to view information relevant to the patient case. When the user clicks on a specific patient name, the patient information relating to that patient is displayed in the fields in the patient information area 405. When various steps in the medical testing process are completed as to the patient, the technologist clicks on and activates the applicable buttons that signify completion of those steps. For example, the technologist clicks on the “ready for exam” button 419 (if this is a step the technologist performs) when the patient is ready to commence the exam, and clicks the “on the table” button 421 once the exam process has commenced as to the patient. The present embodiment also includes an “off the table” button, which is activated by the technologist when the exam is completed (although this button is not displayed in the window 401 of FIG. 4A). The system “time stamps” the technologist's completion of these inputs, and the notation of the step completed is displayed in patient status column 413 and the time the rotation is inputted is displayed in time stamp column 415. The technologist queue window 401 also includes an “omit from time analysis” feature 423, which permits the user to exempt a patient case from time analysis as to completion of specific steps of the medical testing process. Also, it should be noted that the technologist queue, like other patient queues, is updated or “refreshed” according to a time interval selected by a system users, which updates the information in the patient queues, including new information submitted during the time interval.

In the present embodiment, the technologist forwards the film or image produced by the exam process to the system, where it can be accessed by a radiologist, who reviews the film or image and prepares a report for the reviewing physician. In an alternate embodiment of the system, the film or image is accessed directly by another person or organization, without being routed through a medical doctor, such as a radiologist, for review and analysis. For example, test results of alcohol or illegal drug tests might go directly to law enforcement authorities or to an employer representative. In another embodiment, for example, X-ray images are accessed directly by a surgeon preparing to enter the operating room. These individuals do not have work stations linked to the network of the present embodiment, but are accessed remotely by the Internet, or by other cable or wireless means.

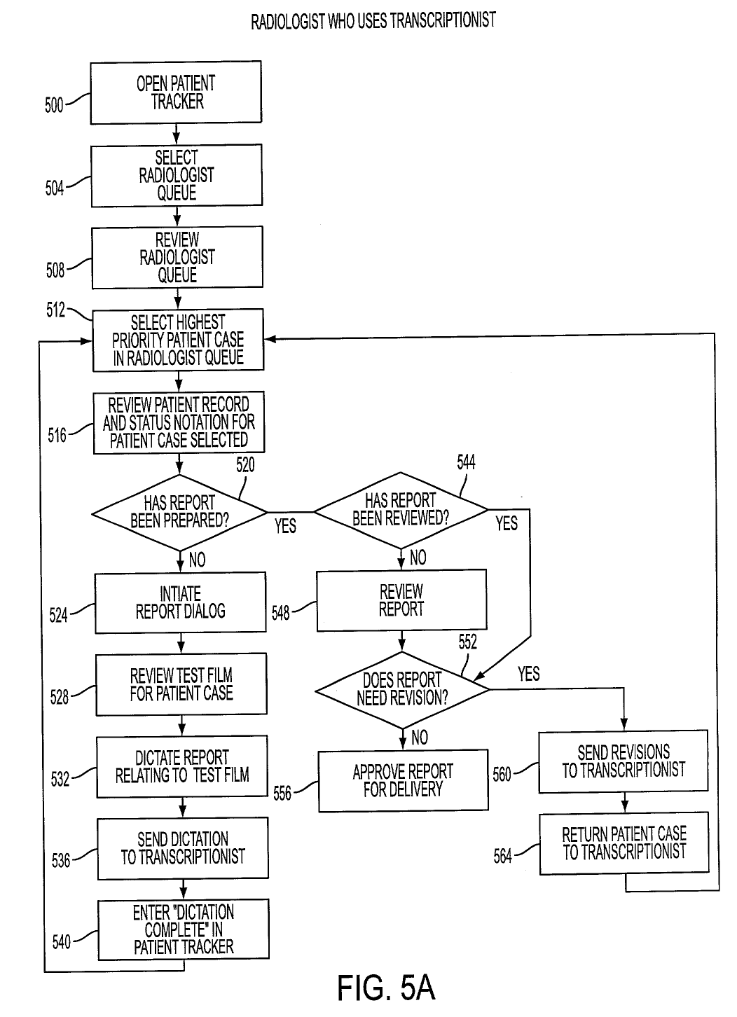

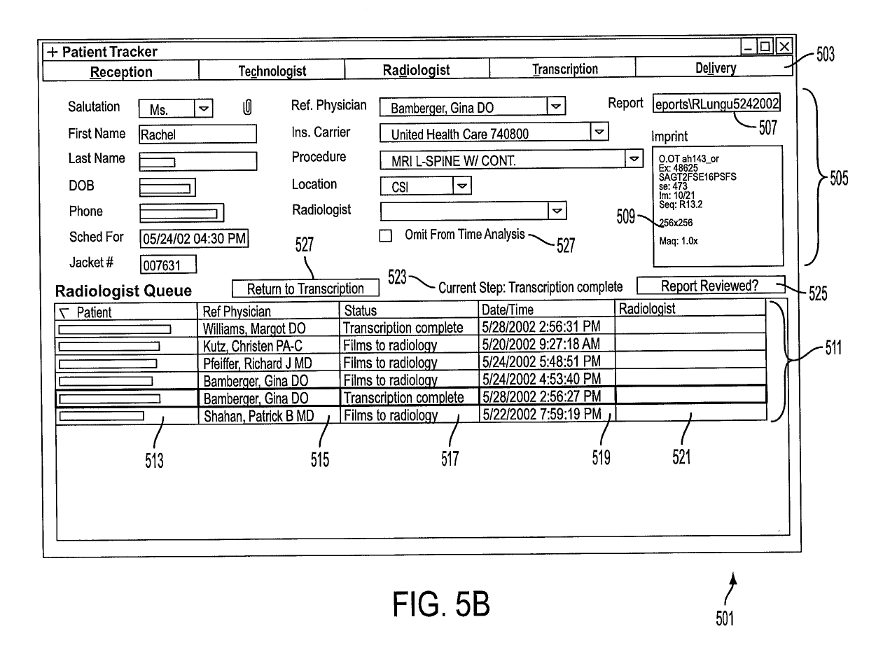

The present embodiment accommodates a radiologist who uses a transcriptionist, as well as a radiologist who prepares reports himself. Referring to FIG. 5, the radiologist who uses a transcriptionist opens the patient tracker 500, selects the radiologist queue 504, and reviews the radiologist queue 508. The radiologist then selects a highest priority patient case from the radiologist queue 512. The radiologist reviews the patient record and the status notation for the patient case selected 516, and checks to see whether a report has been prepared 520. If this patient case involves a film for review, and there is no completed or transcribed report, the radiologist then initiates the patient report dialog 524, reviews the test film 528, dictates a report 532, and sends dictation to the transcriptionist 536, also entering the notation “dictation complete” in the patient tracker 540. The patient case is then sent to the transcriptionist and appears on the transcriptionist's queue. The radiologist returns to the radiologist queue to select the highest priority patient case represented in the queue 512. Depending on the priority rule, this may be another patient case with a film for review, or a patient case with a transcribed report awaiting review. If the highest priority patient case involves reviewing a transcribed report, the radiologist then opens the report, and determines whether the report has been reviewed 544. If the report has not been reviewed, the radiologist reviews the report for accuracy and completeness, consistent with professional and practice standards 548. The radiologist determines whether revisions should be made 552. If not, then the report is approved for delivery 556. If there are revisions to be made, the radiologist sends the revisions to the transcriptionist 560 and returns the case to the transcriptionist 564, by activating the “return to transcriptionist” button. Once the revisions are in the hands of the transcriptionist, the radiologist is free to return to the radiologist queue and attend to the next highest priority patient case in the radiologist queue 512. When the revisions are complete and the patient case once again becomes the highest priority case in the radiologist queue, the radiologist then again reviews the report 548. If the report requires further revision, the radiologist dictates revisions and sends the dictated revisions to the transcriptionist again 560. If the report is ready for delivery, the radiologist approves the report for delivery 556.

FIG. 5A further illustrates the operation of the radiologist queue of the patient tracker application. FIG. 5A displays the radiologist queue window 501 of the present embodiment, which includes a tool bar 503, that enables the user to open other patient queue windows, and a patient information area 505. The radiologist queue window 501 includes a report path indicator 507, which indicates whether a report has been prepared, and an image imprint 509, which includes an image produced by the exam completed as to the patient. The radiologist queue window 501 includes a radiologist queue section 511, which displays the radiologist queue in a chart format, including a patient name column 513, a referring physician column 515, a patient status column 517, displaying the last step in the medical testing process completed as to the patient case in the adjoining patient name column 513, and a time stamp column 519, which displays the date and time the notation of the last step completed was entered as to specific patient cases. As with the other patient queue windows discussed previously, the user can select a patient name in the patient name column 513, click on the name, and thereby call up patient information relating to that patient in the patient information section 505. Also, in the radiologist queue section 511, the radiologist can read along the line to the right of a specific patient name, to obtain information, including last step completed and time stamp information, relating to the specific patient case of interest. The radiologist queue window 501 also includes a radiologist column 521, which can be completed to include the name of the radiologist assigned to the patient case (if a specific radiologist is assigned). The window 501 also includes buttons by which the radiologist can input information regarding work on specific cases, including a “transcription complete” button 523, and a “report reviewed” button 525. Additionally, the radiologist can return the patient case to the transcriptionist by a “return to transcription” button 527 this button deletes the patient case from the radiologist's queue, and adds it to the transcriptionist queue. This button 527 can be used, for example, when the radiologist wishes the transcriptionist to complete further work on the report (such as revisions).

In a further embodiment, the radiologist queue window 501 can include other buttons, by which the radiologist can send the patient case to another patient queue, and delete the patient case from the radiologist's queue. This feature of the system can be utilized with other patient queues, and in other arrangements other users are authorized to relocate patient cases from one patient queue to another, and delete patient cases from selected queues. Finally, the radiologist queue window 501 also includes a time analysis feature that permits the radiologist to delete selected patient 527 cases from the time analysis function of the system.

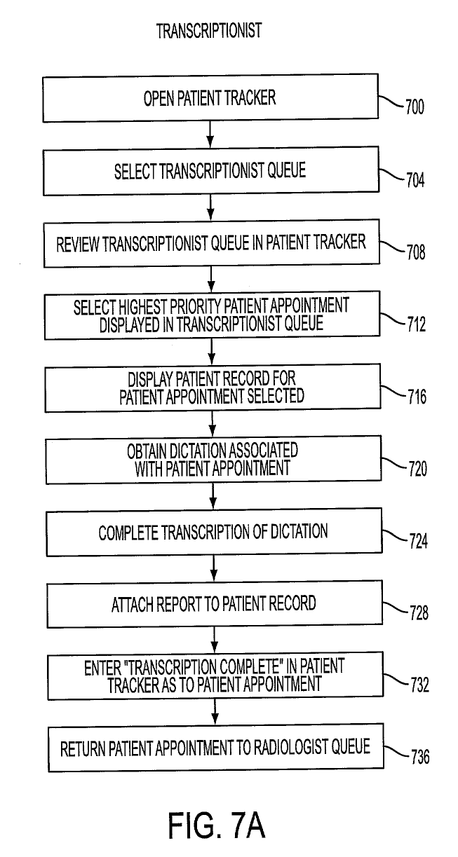

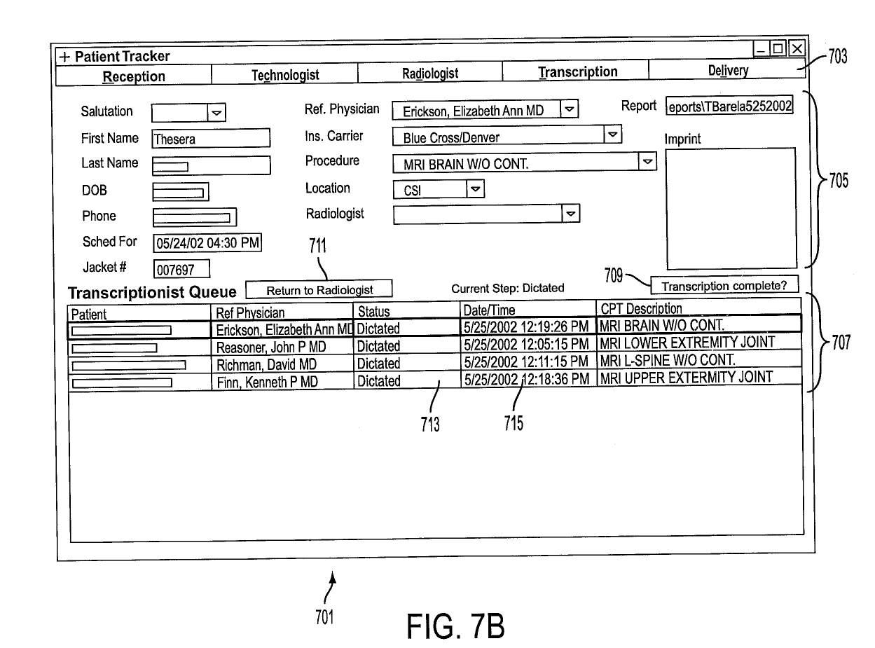

The patient tracker of the present embodiment includes a transcriptionist queue for radiologists who utilize a transcriptionist. Referring to FIG. 7, the transcriptionist opens the patient tracker 700, selects the transcriptionist queue 704, and then reviews the transcriptionist queue 708. The transcriptionist selects the highest priority patient case in the transcriptionist queue based on the priority rule that applies to the queue 712. The transcriptionist displays the patient record associated with the patient case 716, and the last notation entered for that case, and then obtains the most recent dictation of that case 720 and completes the transcription 724. The transcriptionist attaches the transcribed report to the patient record on the patient tracking system 728, and inputs the notation “transcription complete” in the patient tracker 732, which signifies to the radiologist that the report is once again ready for review. Referring to FIG. 5, when this patient case has the notation “transcription complete” it is prioritized for review and on review by the radiologist and approval for delivery, it is sent to staff responsible for delivery.

FIG. 7A further illustrates the transcriptionist queue of the patient tracker, by depicting the window 701Of the transcriptionist queue utilized by the transcriptionist. Referring to FIG. 7A, the transcriptionist queue window 701 includes a tool bar 703, patient information area 705, transcriptionist queue section 707, and buttons for signifying completion of transcription 709, and for returning the patient case to the radiologist 711. The present window 701 displays several dictated cases which are ready for transcription, with the date and time the dictation was completed. For each of the cases noted, the status column 713 indicates “dictated” and the date/time column 715 provides the date and time dictation was completed in the applicable case. As can be seen, the transcriptionist queue window 701 provides a format and functionalities for user interaction with the patient tracker system that closely resemble those of the other patient queues of the present embodiment.

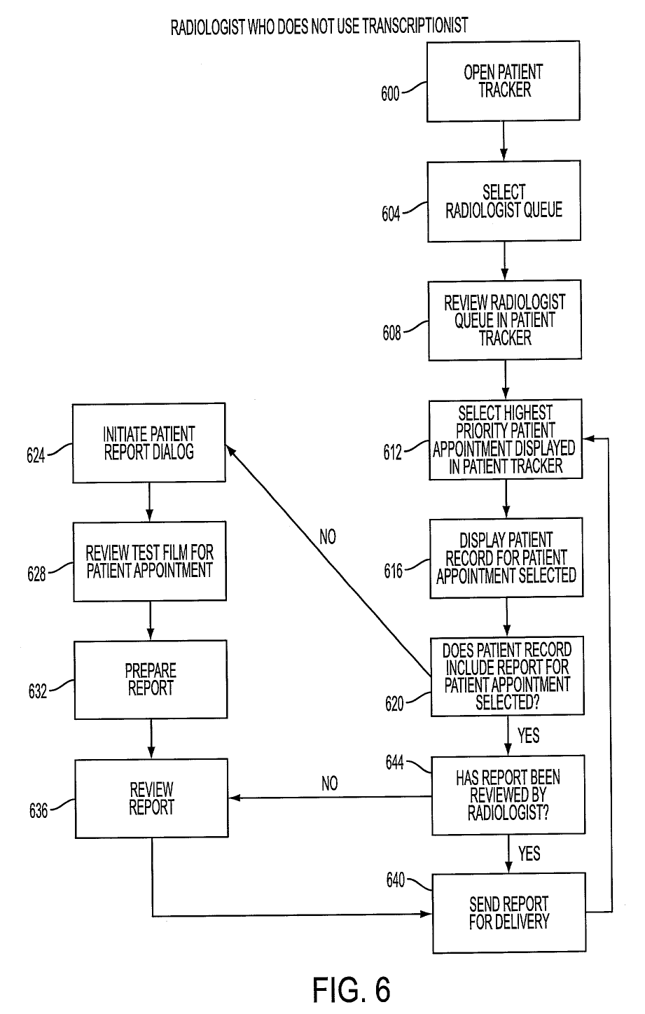

The patient tracker application also accommodates a radiologist who prepares his reports without a transcriptionist. Referring to FIG. 6, the radiologist opens the patient tracker 600, selects the radiologist queue from the relevant toolbar 604, and reviews the radiologist queue 608. He then selects the highest priority patient case displayed in the radiologist queue of the patient tracker 612, and displays the patient record and patient appointment selected, including the notation of the last step completed 616. The system then queries whether there is a report prepared 620. If yes, the system then asks whether the report has been reviewed 644. If not, the radiologist reviews the report 636, makes any necessary changes himself, and approves for delivery 640. If no report has been prepared, the radiologist initiates the patient report dialog 624, reviews the patient's test film 628 (or image, if presented as an image by the system) prepares the report 632, and reviews the report (making any necessary changes) 636, then sends the report for delivery 640. The radiologist clicks “report reviewed” to signify the report is ready for delivery, which displays on the delivery queue, and alerts the staff member responsible for delivery that the report can be sent to authorized recipients.

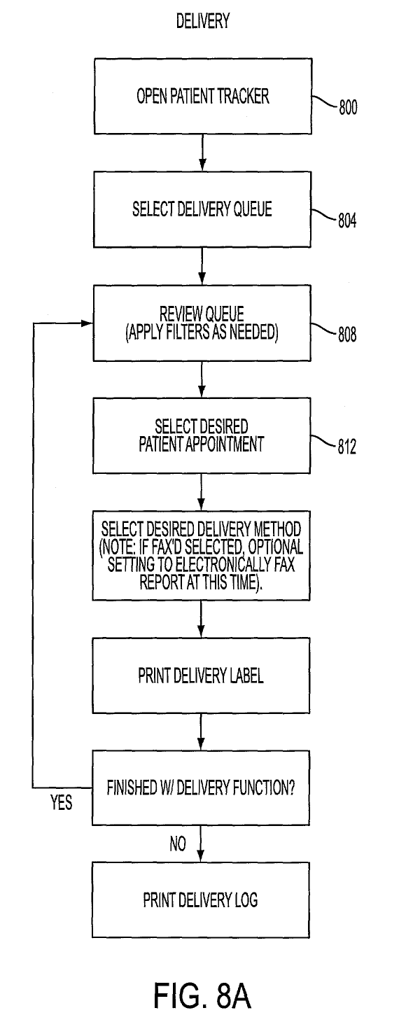

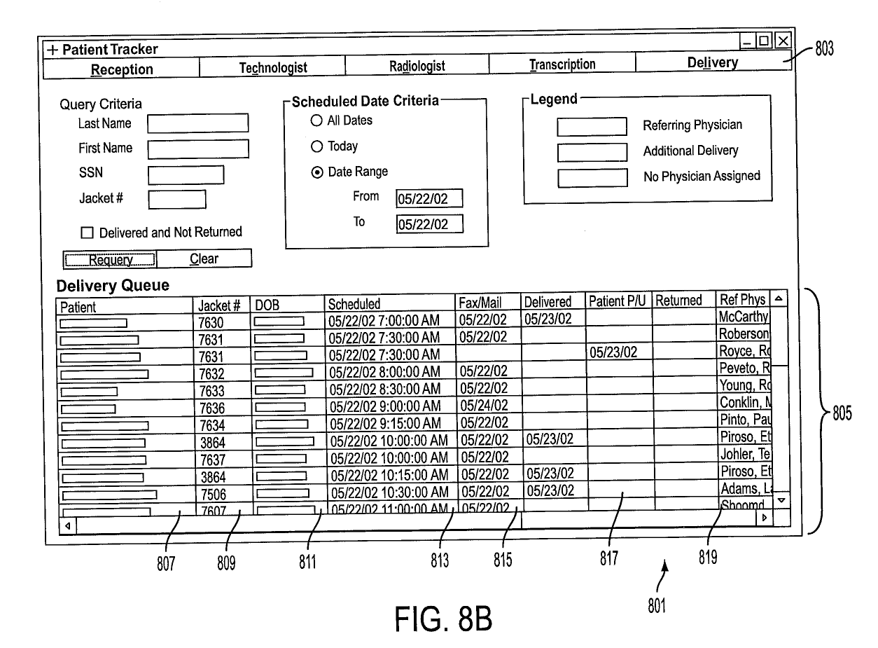

Referring to FIG. 8, the staff member responsible for delivery of an approved report first opens the patient tracker 800, then selects the delivery queue 804 and reviews the delivery queue 808, and selects the patient case with highest priority in the queue 812. The staff member then delivers the report in accordance with either ordinary office routine for delivery or special instructions entered in the patient record.

FIG. 8 illustrates the delivery queue window 801. The delivery queue enables the staff member responsible for delivery to track patient cases in which the completed report is ready for delivery and to record and track the method used for delivery, and other delivery details. As with the other patient queue windows, this window 801 includes a tool bar 803, which permits the user to open other patient queue windows. It also includes a delivery queue section 805, in which the delivery queue is displayed in a chart format, with columns for patient name 807, jacket number 809, patient” date of birth 811, date and time scheduled for appointment 813, and various columns describing methods of delivery, such as Fax/mail 815 and patient pick-up (p/u) 817. The user can enter the date these deliveries were effected, and note the referring physician who received the report 819.

The present embodiment also includes a patient status grid means, for displaying to a user at least a portion of the patient cases appearing in at least one patient queue, and for evaluating the time for completion of various tasks associated with the queue. The patient status grid means operates as another application program configured on the application server. It is integrated with the patient tracker and the scheduler, processing and displaying information inputted through each of those two programs. The patient status grid means can be utilized by users who are performing steps in the medical testing process, independently of the patient tracker, or it can be utilized at the same time as the patient tracker. For example, a radiologist using the patient tracker displays a representation of the radiologist queue on his work station, while viewing an image taken from an MRI film, and preparing a report using the report building functionality. The radiologist checks his patient case workload on the patient tracker, while attending to the report of an individual patient case. Additionally, he can open the patient status grid, as a separate window, and review the status of all patients scheduled for the day, as discussed more fully below, and evaluate the time it is taking to complete steps in patient cases that are ready for his attention at the present time. In one embodiment of the invention, the radiologist toggles between a screen displaying the radiologist queue, and a screen displaying the patient status grid. In another embodiment, the radiologist utilizes a split-screen arrangement to display both the radiologist queue and the patient status grid at the same time. In a further embodiment, the radiologist has two work stations, one displaying the radiologist queue of the patient tracker, and the other displaying the patient status grid.

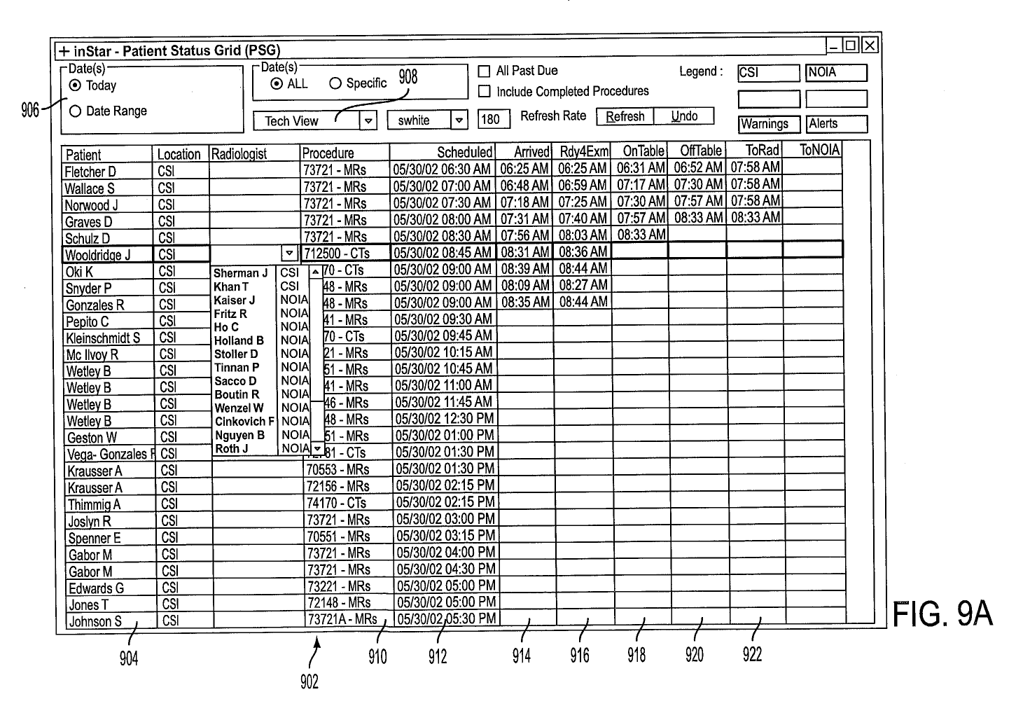

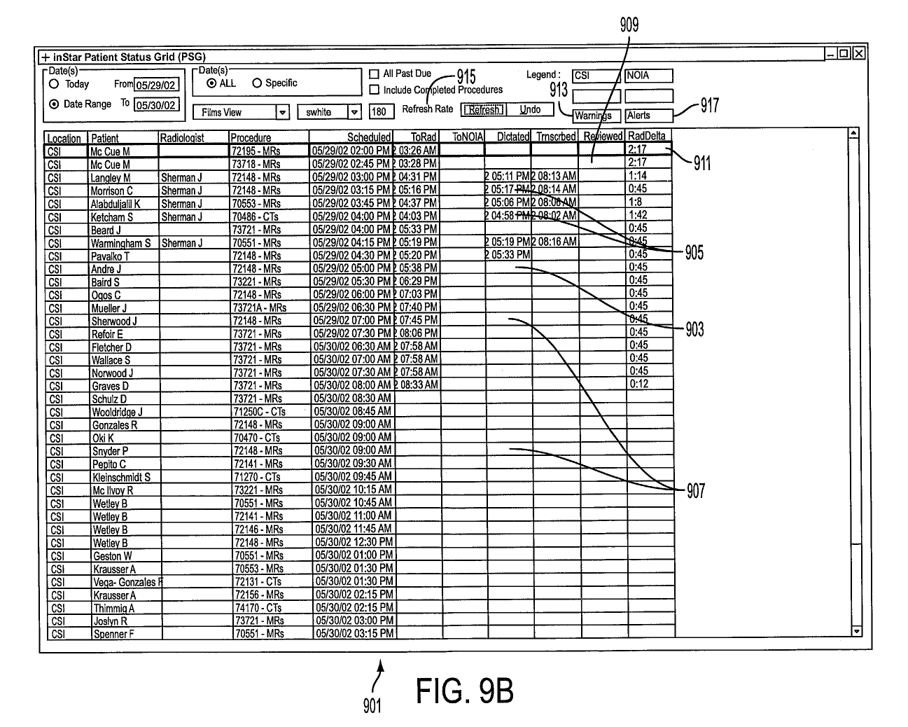

In the present embodiment, the patient status grid means displays a patient status grid window representing a list of patient cases by patient name and test procedure, with date and time each patient case is scheduled, and provides selected steps in the testing process completed and to be completed as to each patient case, with time stamps for each completed step depicted. In the present embodiment, the patient status grid window is displayed in a chart format, although other formats for presenting the information may be used. Referring to FIG. 9, which depicts the patient status grid window 902 viewed by a user, a list of patient names is provided in a far left-hand patient name column 904. Where a patient is scheduled for an appointment involving two procedures, two entries for a given patient name are provided. Additional columns are provided, each column providing information about the status of each patient case, including notations regarding the time each step has been completed.

The patient status grid means has a filtering means, for defining the set of patient cases displayed, according to various parameters. In the present embodiment, the patient cases are selected by date scheduled for the patient's appointment, and the user can specify a particular date or date range via the date functionality 906. The user also specifies the view desired with a view functionality means 908 and, in the present embodiment, the views which displayed include views for each of the patient queues, the receptionist, technologist, radiologist, transcriptionist and delivery queues. The user can establish alternate views, that display other patient queue information, or that display other patient case information. In the present embodiment, each of these views presented includes patient cases included in the relevant queue, with an indication of whether each of the steps tracked by each of these queues has been completed, and a time stamp for completion, which is filled in if the step has been completed and the relevant notation inputted by the user. The patient status grid window 902 displayed in FIG. 9 is the technologist view of the patient status grid. This view is constructed to display information of interest to a technologist conducting radiological tests. In the present patient status grid window 902, there are columns for the type of test procedure 910, data and time appointment scheduled 912, time patient arrived 914, whether patient is ready for exam 916, whether patient is on the table 918, and off the table 920, and whether film has been sent to radiology 922. By reviewing the patient status grid window of FIG. 9, the technologist can determine the progress of patient cases in his area over multiple steps in the medical testing process. It should be noted that the information in the patient status grid can be presented in alternate formats. In alternate embodiments, for example, the information can be presented in a row format, in a series of lists, and also in a three-dimensional format, and the present description is not intended to limit the system to a chart format with multiple columns.

In the present embodiment, the patient status grid means includes a further feature, which is a time analysis means. The time analysis means evaluates time stamps of successive steps, to determine the total time it takes to complete steps in the testing process. Further, in this function, the user enters an expected time of completion of specific steps, which the patient status grid means compares to actual time of completion. Reports are then generated analyzing steps where there is a bottleneck, i.e., where the expected time of completion is exceeded. The system also includes an alert or notice means, for notifying the user of selected events, including when the time for completion of specific steps has exceeded one or more specific time intervals programmed into the system or has exceeded the expected time for completion. This feature helps the user prioritize patient cases, and helps the user to recognize when the processing of specific cases should be expedited to meet practice goals regarding turnaround of test results.

FIG. 9A depicts another view of a patient status grid window 901, denominated a “films view” in FIG. 9A. In the present embodiment, the patient status grid means includes a means for the user of the patient status grid to define the view displayed, including the patient cases and steps included, the kind of time analysis information provided, and the format in which information is displayed. The user also defines the title of the view seen. In this case, the “films view” includes information that would be of interest to a radiologist, although other users of the system might define a view presenting the same or similar information. As will be seen in FIG. 9A, this window includes patient cases and status information regarding whether specific steps, such as dictation, transcription and report review, have been completed. The view of FIG. 9A provides further illustration of the time analysis means of the present system, including the warning and alert means. In the present embodiment, the user programs the system to define a time interval after which a warning or alert will be issued. This time interval is a time interval after completion of one step in the medical testing process, and before completion of the next step in the medical testing process. If the defined time interval as inputted by the user for a specific step is exceeded, the system will issue a notice that is visible to the user on the window of the patient status grid. In the present system, one such notice is called a “warning.” The embodiment of the system depicted in FIG. 9A also permits the user to input a longer time interval between steps after which another notice will be issued to the user. In the present system the second notice is called an “alert” Warnings are seen by the user as an orange shaded area in the slot on the relevant column of the patient status grid where the time for completion of a specific step would be entered (if the step were completed and a notation of completion entered by the user). Alerts are seen as red shaded areas in the time slots of the step completion columns. The system is not limited to this means of issuing a notice, and another format for issuing a notice could be used, including use of warning or alert figures or boxes in other areas of the window, and different colors for notices. The present system, however, provides notices as to delays in completion of individual steps in the medical testing process as applied to specific patient cases, and the patient status grid enables the user to see an entire patient case load, or portion of a patient case load, for a specific area or staff member, with notations for steps completed, and relevant time stamps, and notices where the time for completion of specific steps is approaching or has exceeded an expected value. Additionally, and referring to FIG. 9A, the present embodiment of the patient status grid means includes a time difference column 911 (titled “RadDelta” in this embodiment) and functionality, which enables the user to instruct the system to calculate the time which it has taken for specific steps to be completed and the time elapsed from completion of a previous step. Where the time for completion or the time elapsed has exceeded a given value, which can be entered into the system, the system also is programmed to issue notices, such as warnings or alerts like those described above, in specific areas of the patient status grid window. In the present embodiment, these calculated time differences are entered in the time difference column 911, and notices to the user, that these time intervals exceed a defined value, appear as colored shading that appears over the time slot where the time differences are entered. Like other columns in the patient status grid, the time difference column 911 is user defined. The user establishes more than one time difference column, or presents the window without a time difference column. The user defines what steps are analyzed and what time calculations are thereafter displayed in the time difference column. The use defines the title of the time difference column (and other columns in the grid display) in order that the user will recognize what step has been analyzed and what calculation has been performed.

In the present embodiment, the patient status grid means also includes a user-defined refresh rate, which determines the time interval over which the system will update information on the patient status grid, adding newly inputted information. The user modifies the refresh rate by adjusting the refresh rate functionality 915, causing the system to be refreshed and updated more or less frequently.

The present system permits users to prioritize cases in the patient status grid means on the basis of whether a defined time interval has been exceeded. For example, the user can instruct the system to provide a view of all patient cases in the user's patient queue (or another's patient queue) in which a warning or alert has been issued. Referring to FIG. 9A, by activating the warnings button 913, the user views a list of all cases where warnings have been issued as to the last step completed in the medical testing process. The same is done as to cases where alerts have been issued, by activating the alerts button 917. The system further provides a means for preparing a report, analyzing the actual time for completion of each step in various medical testing processes, versus the expected time for completion, and generating an analysis of practice efficiency in each of the patient queue areas. Users of the system thereby determine where there are bottlenecks in completion of specific steps.

It should be noted that the present embodiment of the system also includes a remote access means, involving communications over the Internet. In this aspect, the system includes creation of a web page, which an authorized user accesses from a remote location, by entering specified log in information and access codes. Once the user gains access the user accesses a specific patient queue of the patient tracker application and the patient status grid application, and interacts with the system in the same way as a network user would interact with the system. For example, in this embodiment, a radiologist obtains access to the radiologist queue, calls up images of films, and prepares reports, while accessing the system from a remote location through the system web page.

The present description is not intended to limit the system to the embodiments described herein, and other embodiments may carry out the elements and functions of the system with like effect and benefits.

We claim:

1. A computer system for managing medical testing for a plurality of patient cases, each patient case involving a single patient undergoing at least one medical test having multiple steps that include data collection and data evaluation, said computer system comprising:
a computer network including
server means for receiving, sending, storing and processing data reflective of a plurality of patient cases, said server means including
processor means configured to process said data in accordance with a program configured to include
scheduling means for scheduling each of said patients of said plurality of patient cases for an appointment to undergo at least one medical test having multiple steps that include data collection and data evaluation,
patient tracking means for ordering and monitoring a plurality of patient cases, including
patient queue definition means for establishing a set of patient queues for at least one of said multiple steps in said medical testing process,
each of said patient queues having data reflective of a patient case, patient queue priority means for establishing a sequence in which the patient case is to be assigned to the patient queue for each step of said multiplesteps,
memory means interconnected to said processor, said memory means configured for storing data reflective of said patient cases;
cable means connected to said server for receiving and sending said data reflective of said plurality of patient cases; and
a plurality of work stations, each connected to cable means, each of said work stations having configured with an input means to receive user inputs of data for said patient case and an output means to display data of said patient case; each of said plurality of work stations including means inputting, on completion of each step in said medical testing process as to each patient case, a notation confirming completion of said step as to said patient case.

2. The system of claim 1, wherein said set of patient queues comprises:
an exam administration queue, representing a step of administering exam to patient, and
a radiologist queue, representing a step of preparing a radiologist's report.

3. The system of claim 1, wherein said set of patient queues comprises:
a reception queue, representing a step of confirmation that patient is ready for exam,
an exam administration queue, representing steps of commencement of exam, completion of exam, and sending film to radiology, and
a radiologist queue, representing steps of reviewing film, preparing report, and approving report for delivery.

4. The system of claim 1, wherein said set of patient queues comprises:
a reception queue, representing steps of confirmation of patient arrival, and confirmation that patient is ready for exam,
an exam administration queue, representing a step of administering exam to patient,
a radiologist queue, representing steps of completing dictation of report and approving report for delivery, and
a transcriptionist queue, representing a step of completing transcription of report.

5. A system of claim 3, wherein said representation of said radiologist queue includes at least one patient case having a notation indicating last step completed was commencement of exam, at least one patient case having a notation indicating last step completed was sending film to radiology, and at least one patient case having a notation indicating last step completed was reviewing film.

6. The system of claim 1, wherein said patient status input means comprises also an input function that permits a user to add a patient case located in a first patient queue to a second patient queue.

7. The system of claim 4, wherein said patient status input means comprises also an input function that permits a user to add a patient case located in said radiologist queue to said transcriptionist queue.

8. The system of claim 4, wherein said patient status input means comprises also an input function that permits a user to return a patient case located in said radiologist queue to said exam administration queue.

9. The system of claim 1, wherein said patient locator means first assigns a patient case to a first patient queue, and then on user inputs indicating completion of selected steps associated with said first patient queue for said patient case, adds said patient case to a second patient queue.

10. The system of claim 1, wherein said patient locator means first assigns a patient case to a first patient queue, and on entry of inputs indicating completion of selected steps associated with said first patient queue for said patient case, adds said first case to a second patient queue, and on entry of inputs indicating completion of selected steps associated with said second patient queue, deletes said patient case from at least said first patient queue.

11. The system of claim 1, wherein said patient tracking means further comprises a time stamp means, including
means for recording the time of inputting each notation confirming completion of a step as to a patient case, and
means for displaying said time of inputting each said notation on said representation of each said patient queue in association with the associated patient case and step completed.

12. The system of claim 11, further comprising a business rule means, including a means for inputting an expected time for completion of each step;
a means for calculating an actual time of completion of each step for each patient case;
a means for comparing said expected time and said actual time of each said step, and a means for issuing a notice to said user when said expected time is exceeded.

13. The system of claim 11, further comprising
a patient status grid means, for displaying to a user on at least one work station in a grid format at least a portion of said patient cases assigned to at least one patient queue on an appointment day, in a display arrangement including:
a means for identifying patient cases of said portion by patient names;
a means for identifying the time each patient is scheduled for an appointment; and
a means for displaying the time a notation is entered signifying completion of each step in said medical testing process, but leaving blank steps wherein no notation has been entered,
the grid arranged such that a user can find a patient name in the patient case column, and read horizontally to the right the time of completion of each completed step in said medical testing process associated with said patient in said additional columns.
